(19) United States
(12) Patent Application Publication
(10) Pub. No.: US 2026/0108864 A1
(43) Pub. Date: Apr. 23, 2026

(54) MIXED LINKER ZINC-TRIAZOLE-OXALATE MOF COMPOSITIONS FOR CO2 ADSORPTION

(71) Applicant: NuMat Technologies, Inc., Chicago, IL (US)

(72) Inventor: Brian G. Hashiguchi, Naperville, IL (US)

(73) Assignee: NuMat Technologies, Inc., Chicago, IL (US)

(21) Appl. No.: 19/353,190

(22) Filed: Oct. 8, 2025

Related U.S. Application Data
(60) Provisional application No. 63/709,909, filed on Oct. 21, 2024.

(51) Int. Cl. B01J 20/22; B01D 53/04; B01D 53/047

(52) U.S. Cl. CPC B01J 20/226; B01D 53/0462; B01D 53/047; B01D 2253/204; B01D 2257/504

(57) ABSTRACT

A MOF composition is formed from a reaction mixture comprising zinc ions, oxalate, and one or more substituted cycloazocarbyl compounds selected from either (a) at least two different cycloazocarbyl compounds, each of which is at least mono-substituted, or (b) at least one cycloazocarbyl compound that is di-substituted. The MOF composition can be used in a method of capturing carbon dioxide from a mixture of gases containing carbon dioxide. Also disclosed herein is a method of making the MOF composition.

### FIELD OF THE DISCLOSURE

This disclosure relates to adsorbent compositions comprising metal organic framework (MOF) compositions, which MOF compositions are the reaction product of a reaction mixture comprising zinc ions, oxalate, and either (a) at least two cycloazocarbyl compounds, each of which is at least mono-substituted, or (b) at least one cycloazocarbyl compound that is di-substituted and at least one other cycloazocarbyl compound that is either unsubstituted or monosubstituted; and to methods of making such MOF compositions and such adsorbent compositions. This disclosure further relates to methods and apparatuses for adsorbing CO₂ from a mixture of gases comprising CO₂ using such adsorbent compositions comprising said MOF compositions.

### BACKGROUND OF THE DISCLOSURE

Carbon dioxide is a known greenhouse gas. It would be desirable to remove CO₂ by adsorption, either directly from the atmosphere or at point sources of CO₂, such as industrial flue gases.

Metal organic frameworks are porous solids comprising organic linkers connecting metal-containing nodes to form a framework. The metals of the nodes and the linkers each can be selected to produce MOFs that have adsorption capabilities for particular gases. Efforts have been made to use metal organic framework (MOF) compositions to capture carbon dioxide, both directly from the air and from higher CO₂ containing effluents, such as industrial flue gases. Such efforts are described, for example, in U.S. Pat. Nos. 9,782,745, 11,230,562, US 2024/0190898, and Wang et al., J. Am. Chem. Soc., 2024, 146, 6, 3943-3954.

One challenge in developing MOFs for adsorption of a particular gas is to design the MOF so that it preferentially adsorbs the gas of interest while adsorbing less of other gases that might be present in a mixture. Gas mixtures that contain carbon dioxide may also can contain gases such as nitrogen and water vapor. It would be desirable to provide a MOF composition that preferentially adsorbs CO₂ over nitrogen and water vapor.

Another challenge with MOF adsorbents is that not all MOF compositions possess long-term stability in the presence of water vapor. It therefore would be desirable to provide a MOF composition that preferentially adsorbs CO₂ over nitrogen and water vapor, and that is stable in the presence of water vapor.

### SUMMARY OF THE DISCLOSURE

Provided herein is an adsorbent composition comprising a metal-organic framework (MOF) composition wherein the MOF composition is the reaction product of a reaction mixture comprising zinc ions, oxalate, and one or more substituted cycloazocarbyl compounds selected from either (a) at least two different cycloazocarbyl compounds, each of which is at least mono-substituted, or (b) at least one cycloazocarbyl compound that is di-substituted, and at least one cycloazocarbyl compound that is either unsubstituted or monosubstituted. In one embodiment the substituents on the at least two different mono-substituted cycloazocarbyl compounds and the disubstituted cycloazocarbyl compounds are independently selected from the group consisting of methyl, ethyl, propyl, NR′R″ where R′ and R″ are independently selected from H and C1-C3 alkyl, halide, thiol, and heteroalkane, In one embodiment the substituents on the at least two different mono-substituted cycloazocarbyl compounds and the disubstituted cycloazocarbyl compounds are independently selected from the group consisting of methyl, ethyl, propyl and NR′R″, where R′ and R″ are independently selected from H and C1-C3 alkyl. In one embodiment the at least mono-substituted cycloazocarbyl compounds are selected from the group consisting of 3-methyl-1,2,4-triazole (MTZ) and 3-amino-1,2,4-triazole (ATZ). In one embodiment the di-substituted cycloazocarbyl compound is selected from the group consisting of 3,5-diamino-1,2,4-triazole and 3,5-dimethyl-1,2,4-triazole. In one embodiment the MOF composition comprises both NR′R″ substituted cycloazocarbyl compounds and C1-C3 alkyl substituted cycloazocarbyl compounds. In one embodiment the at least one cycloazocarbyl compound that is either unsubstituted or monosubstituted can be selected from 3-methyl-1,2,4-triazole (MTZ), 3-amino-1,2,4-triazole (ATZ), and 1,2,4-triazole.

The MOF compositions as disclosed herein can serve as adsorbents that adsorbs carbon dioxide from a gas mixture comprising carbon dioxide. In some embodiments the MOF compositions disclosed herein have higher adsorption for CO₂ than for either N₂ or water vapor under selected adsorption conditions. In some embodiments the MOF compositions disclosed herein have higher adsorption for CO2 than for both N2 and water vapor under selected adsorption conditions.

In some embodiments the MOF compositions provide good stability in high humidity conditions.

Also provided herein is a method of making a metal-organic framework (MOF) composition by reacting a reaction mixture comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted, and at least one cycloazocarbyl compound that is either unsubstituted or monosubstituted, the method comprising providing an aqueous mixture comprising oxalic acid and either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted, adding a zinc precursor to the mixture to form a reaction mixture, and reacting the reaction mixture to form a MOF composition comprising zinc, oxalate, and either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted.

In one embodiment the method comprises the further step of separating the MOF composition from the reaction mixture.

Also provided herein is an apparatus comprising an adsorbent composition comprising a metal-organic framework (MOF) composition wherein the MOF composition is the reaction product of a reaction comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted, and at least one cycloazocarbyl compound that is either unsubstituted or monosubstituted. The apparatus can be used to separate carbon dioxide from a gas mixture comprising carbon dioxide by allowing the gas mixture to come into contact with said adsorbent composition.

Also provided herein is a method of removing carbon dioxide from a gas mixture comprising carbon dioxide, the method comprising exposing the gas mixture to an adsorbent composition comprising a metal-organic framework (MOF) composition wherein the MOF composition is the reaction product of a reaction mixture comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted.

In some embodiments the MOF composition that has adsorbed carbon dioxide can be regenerated by either heating, or evacuating, or heating and evacuating the metal organic framework composition that has adsorbed carbon dioxide to remove the adsorbed carbon dioxide from the MOF composition.

### DESCRIPTION OF THE FIGURES

FIG. 1 is a graph showing CO₂ isotherms for zinc-oxalate-cycloazocarbyl MOF compositions of Comparative Examples A-C and Working Examples 1-3.

FIG. 2 is a graph showing N₂ isotherms for zinc-oxalate-cycloazocarbyl MOF compositions of Comparative Examples A-C and Working Examples 1-3.

FIG. 3 is a graph showing H₂O isotherms showing adsorption and desorption curves for zinc-oxalate-cycloazocarbyl MOF compositions of comparative examples A-C and Examples 2 and 3.

FIG. 4 is a stack plot showing PXRD spectra for zinc-oxalate-cycloazocarbyl MOF compositions s of comparative examples B-C and Examples 1-3.

FIG. 5 is a graph showing CO₂ isotherms for zinc-oxalate-cycloazocarbyl MOF compositions of Comparative Examples A, C, D, E, and F.

FIG. 6 is a graph showing N₂ isotherms for zinc-oxalate-cycloazocarbyl MOF compositions of Comparative Examples A, C, D, E, and F.

FIG. 7 is a stack plot showing PXRD spectra for zinc-oxalate-cycloazocarbyl MOF compositions of Comparative Examples A, C, D, E, and F.

FIG. 8 is a graph showing CO₂ isotherms for zinc-oxalate-cycloazocarbyl MOF compositions of Comparative Examples A, B, G, H and I.

FIG. 9 is a graph showing N₂ isotherms for zinc-oxalate-cycloazocarbyl MOF compositions of Comparative Examples A, B, G, H and I.

FIG. 10 is a stack plot showing PXRD spectra for zinc-oxalate-cycloazocarbyl MOF compositions of Comparative Examples A, B, G, H and I.

FIG. 11 is a graph showing CO₂ isotherms for zinc-oxalate-cycloazocarbyl MOF compositions of Comparative Example A and Working Examples 4 and 5.

FIG. 12 is a graph showing N₂ isotherms for zinc-oxalate-cycloazocarbyl MOF compositions of Comparative Example A and Working Examples 4 and 5.

FIG. 13 is a stack plot showing PXRD spectra for zinc-oxalate-cycloazocarbyl MOF compositions of Comparative Example A and Working Examples 4 and 5.

FIG. 14 is a graph showing CO₂ isotherms for zinc-oxalate-cycloazocarbyl MOF compositions of Comparative Example B and Working Examples 6, 7, and 8.

FIG. 15 is a graph showing N₂ isotherms for zinc-oxalate-cycloazocarbyl MOF compositions of Comparative Example B and Working Examples 6, 7 and 8.

FIG. 16 is a stack plot showing PXRD spectra for zinc-oxalate-cycloazocarbyl MOF compositions of Comparative Example B and Working Examples 6, 7 and 8.

FIG. 17 is a graph showing CO2 isotherms for zinc-oxalate-cycloazocarbyl MOF compositions of Comparative Example A and Working Examples 9 and 10.

FIG. 18 is a graph showing N₂ isotherms for zinc-oxalate-cycloazocarbyl MOF compositions of Comparative Example A and Working Examples 9 and 10.

FIG. 19 is a stack plot showing PXRD spectra for zinc-oxalate-cycloazocarbyl MOF compositions of Comparative Example A and Working Examples 9 and 10.

FIG. 20 is a graph showing CO₂ isotherms for zinc-oxalate-cycloazocarbyl MOF compositions of Comparative Example C and Working Examples 11 and 12.

FIG. 21 is a graph showing N₂ isotherms for zinc-oxalate-cycloazocarbyl MOF compositions of Comparative Example C and Working Examples 11 and 12.

FIG. 22 is a stack plot showing PXRD spectra for zinc-oxalate-cycloazocarbyl MOF compositions of comparative example C and Examples 11 and 12.

FIG. 23 is a graph showing carbon dioxide uptake versus the ratio of 3-amino-1,2,4-triazole (ATZ) 3-methyl-1,2,4-triazole (MTZ).

### DETAILED DESCRIPTION OF THE DISCLOSURE

Provided herein is an adsorbent composition comprising a metal-organic framework (MOF) composition wherein the MOF composition is the reaction product of a reaction mixture comprising zinc ions, oxalate, and one or more substituted cycloazocarbyl compounds selected from either (a) at least two different cycloazocarbyl compounds, each of which is at least mono-substituted, or (b) at least one cycloazocarbyl compound that is di-substituted and one cycloazocarbyl compound that is either unsubstituted or mono-substituted. In one embodiment the substituents on the at least two different mono-substituted cycloazocarbyl compounds and the disubstituted cycloazocarbyl compounds are independently selected from the group consisting of methyl, ethyl, propyl, NR′R″ where R′ and R″ are independently selected from H and C1-C3 alkyl, halide, thiol, and heteroalkane, In one embodiment the substituents on the at least two different mono-substituted cycloazocarbyl compounds and the disubstituted cycloazocarbyl compounds are independently selected from the group consisting of methyl, ethyl, propyl and NR′R″, where R′ and R″ are independently selected from H and C1-C3 alkyl. In one embodiment the one or more substituted cycloazocarbyl compounds are substituted triazoles. In one embodiment the substituted cycloazocarbyl compounds are substituted 1,2,4-triazoles. In one embodiment the at least mono-substituted cycloazocarbyl compounds are selected from the group consisting of 3-methyl-1,2,4-triazole (MTZ) and 3-amino-1,2,4-triazole (ATZ). In one embodiment the di-substituted cycloazocarbyl compound is selected from the group consisting of 3,5-diamino-1,2,4-triazole and 3,5-dimethyl-1,2,4-triazole. In one embodiment the MOF comprises both NR′R″ substituted cycloazocarbyl compounds and C1-C3 alkyl substituted cycloazocarbyl compounds.

Disclosed herein is an adsorbent composition comprising a metal-organic framework (MOF) composition useful for adsorbing CO₂. More specifically the MOF composition has pores and is the react ion product of a reaction mixture comprising zinc ions, oxalate, and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted. In an embodiment, the cycloazocarbyl compounds are at least bidentate. In an embodiment, the ring of the substituted cycloazocarbyl compound is a 5-membered ring having 2, 3 or 4 nitrogen atoms. In an embodiment, the substituted cycloazocarbyl compound is a substituted imidazolate, triazolate or tetrazolate. In an embodiment, the substituted cycloazocarbyl compound is a triazolate. In specific embodiments the zinc ion is Zn₂⁺.

In one specific embodiment, at least one substituted cycloazocarbyl compound is 3-methyl-1,2,4-triazole (MTZ) and at least one substituted cycloazocarbyl compound is 3-amino-1,2,4-triazole (ATZ).

In one embodiment the MOF further comprises an unsubstituted cycloazocarbyl compound. In one embodiment the unsubstituted cycloazocarbyl compound is 1,2,4-triazole.

In one embodiment, he MOF composition is substantially non-porous with respect to nitrogen, preferably less than 125 cm³/g STP at 77K.

In one embodiment, the MOF compositions will have a BET surface area of less than 400 m²/g determined according to a 77K nitrogen gas isotherm fit to a BET model.

In one embodiment, the MOF composition retains its ability to adsorb CO₂ at humidity levels of at least 40%, or at least 50% or at least 60% or at least 70% or at least 80% or at least 90%.

In the embodiment in which the MOF composition comprises at least two different cycloazocarbyl compounds, the two compounds may be present in the reaction mixture in varying molar ratios. In one embodiment, the molar ratio of the at least two different cycloazocarbyl compounds in the reaction mixture is in the range of 20:1 to 1:20, or 15:1 to 1:15, or 10:1 to 1:10, or 5:1 to 1:5, or 3:1 to 1:3. When using mono substituted cycloazocarbyl compounds or mixtures of monosubstituted and unsubstituted cycloazocarbyl compounds, the ratio of the two cycloazocarbyl compounds in the reaction mixture is essentially unrestricted. It was found that MOFs would not form when only disubstituted cycloazocarbyl compounds were used in the reaction mixture; without being bound by theory, it is believed that due to steric hindrance introduced with these compounds the MOF is unable to form. It was surprisingly found that MOF compositions could be produced with mixtures of disubstituted cycloazocarbyl compounds with unsubstituted or monosubstituted cycloazocarbyl compounds.

In an embodiment, provided herein is a porous, metal-organic framework (MOF) composition wherein the MOF composition is the reaction product of a reaction mixture comprising zinc ions, oxalate, and a one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted. In an embodiment, the substituted cycloazocarbyl compounds are substituted triazole compounds. In an embodiment, the substituted cycloazocarbyl compounds are substituted 1,2,4-triazole compounds. In an embodiment, the MOF further comprises 1,2,4-triazole.

In an embodiment, provided herein is a metal-organic framework (MOF) composition comprising a plurality of nodes, each node comprising a zinc ion coordinately bound to at least one oxalate and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted, wherein the one or more substituted cycloazocarbyl compounds and the at least one oxalate are coordinately bound to the zinc ion of an adjacent node, wherein the plurality of linked cores defines nodes within the framework.

In one embodiment the MOF composition comprises 3-amino-1,2,4-triazole and 3,5-diamino-1,2,4-triazole.

In one embodiment the MOF composition comprises 1,2,4-triazole and 3,5-dimethyl-1,2,4-triazole.

In one embodiment the MOF composition comprises 3-amino-1,2,4-triazole and 3,5-dimethyl-1,2,4-triazole.

In one embodiment the MOF composition comprises 1,2,4-triazole and 3,5-diamino-1,2,4-triazole.

In one embodiment the MOF composition comprises 3-methyl-1,2,4-triazole and 3,5-diamino-1,2,4-triazole.

Also provided herein is a method of making an adsorbent composition comprising at least one metal-organic framework (MOF) composition comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted, the method comprising providing an aqueous mixture comprising oxalic acid and either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted, adding a zinc precursor to the mixture to form a reaction mixture, and reacting the reaction mixture to form a MOF composition comprising zinc, oxalate, and either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted.

The reaction can be carried out in water, or a mixture of water and an organic solvent. In one embodiment the reaction is carried out in water, with no organic solvent present. If organic solvent is used, in one embodiment the organic solvent can comprise an alcohol, preferably a C1-C4 alcohol. In one embodiment, the solvent or solvent mixture is one in which the oxalic acid and the one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted are soluble, at the concentrations and reaction conditions of the synthesis. In one embodiment, the reaction mixture will be a solution. In one embodiment the reaction mixture will be a suspension.

In one embodiment the zinc precursor is in the form of a zinc salt such as a carbonate salt, or a zinc carbonate precursor such as a mixture of zinc salt and a carbonate salt. In one embodiment the zinc is added as Zinc(II) Biscarbonate(hexahydroxide). In one embodiment the zinc precursor is in the form of zinc oxides or zinc hydroxides, or mixtures zinc salts and hydroxide salts.

The reaction mixture can be heated to initiate the synthetic reaction. The reaction mixture can be heated to a temperature below the boiling point of the solvent. In one embodiment the reaction temperature can be at least 30° C., or at least 40° C., or at least 50° C., or at least 60° C., or at least 70° C., or at least 80° C., or at least 90° C. The reaction can be allowed to continue for at least an hour, or at least 5 hours, or at least 10 hours, or at least 15 hours, or at least 20 hours.

The resulting solids can be separated from the reaction mixture and washed with solvents. Suitable solvents for washing include water, alcohol, and water/alcohol mixtures. The solids can be dried, such as at room temperature. In one embodiment the resulting solids can be activated, such as at 100° C. and optionally under reduced pressure.

Also disclosed herein is a method of separating carbon dioxide from a gas mixture comprising carbon dioxide, the method comprising contacting the gas mixture with an adsorbent composition comprising a MOF composition as disclosed herein, namely, a MOF composition that is the reaction product of a reaction mixture comprising zinc ions, oxalate, and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted.

The MOF compositions as disclosed herein are characterized by the following properties. In some embodiments the MOF compositions have a Brunauer-Emmett-Teller (BET) surface area less than 400 or less than 300 or less than 200, or less than 100 m²/g, determined according to a 77K nitrogen gas isotherm fit to a BET model. In some embodiments the MOF compositions have an average crystallite size of at least 1 μm, or at least 5 μm, or at least 50 μm. More particularly the crystallite size is from about 1 μm to about 100 μm or from about 1 to about 10 or from about 10 to about 50 μm. By crystallite size is meant the size of the individual crystals and not the size of crystals that have been agglomerated into aggregates. When an average size is given, e.g. 1 μm it is understood that the crystals have that particular average size in at least one dimension while the size in the other two dimensions may be less or more. The MOF compositions as disclosed herein can be in the form of individual crystals or in the form of aggregates, or a mixture thereof.

MOFs have the general property of having an open pore system. The MOF compositions as disclosed herein have an average pore size of about 2 to about 20 Å, or from about 2 to about 10 A, or from about 2 to about 7 Å.

Although the MOF compositions as disclosed herein can be used in the powder form, it may be advantageous to form the MOF composition into various shaped bodies such as pellets, spheres, disks, monolithic bodies, irregularly shaped particles and extrudates. The methods of forming these types of shapes are well known in the art. The MOF compositions can be formed into various shapes by themselves or by including a binder. When selecting a binder, it is important to select a binder such that the surface area and adsorption capacity is not adversely affected once the desired shaped body is formed. Materials which can be used as binders include without limitation cellulose, silica, carbon, alumina, and mixtures thereof. Binders which can be used include both organic and inorganic binders. Examples of inorganic binders include but are not limited to clays such as kaolin, attapulgite, and boehmite, aluminas, silicas, metal oxides, and mixtures thereof. Specific examples of organic binders include but are not limited to polymers, e.g. polyvinylpyrrolidone (PVP), starches, gelatin, cellulose, cellulose derivatives, sucrose, polyethylene glycol, and mixtures thereof.

The forming process usually involves preparing a thick paste-like material by mixing the MOF composition with a solvent or a binder plus a solvent. Once the paste-like material is formed it can be extruded through a die having holes of about 1-2 mm to form extrudates of varying length, e.g. 6-10 mm. The paste or even the powder itself can be pressed at high pressure to form pellets or pills. Other means of forming shapes include pressure molding, metal forming, pelletizing, granulation, extrusion, rolling methods and marumerizing.

In yet another aspect of the disclosure, the MOF compositions can be deposited onto articles such as, but not limited to, monoliths, spherical supports, ceramic foams, glass fibers, woven fabrics, nonwoven fabrics, membranes, pellets, extrudates, irregularly shaped particles, and mixtures thereof. When the desired article is a monolith, spherical support, ceramic foam, pellets, extrudates, or irregularly shaped particles, a slurry of the MOF composition is prepared and deposited on the article by means such as dipping, spray drying, etc. followed by drying and optionally calcination. For membranes it is possible to form the MOF composition directly on the membrane. The MOF compositions of the disclosure can be deposited or dispersed onto fabrics (woven and non-woven) or polymers by techniques such as electro-spinning, direct crystal growth, and layer by layer deposition.

The articles containing MOF compositions described in the previous paragraphs can be used as adsorbents to purify air or other gas streams containing contaminants such as carbon dioxide. The air or other gas streams can be flowed through the article, e.g. monolith, foam, membranes, fabrics whereby the MOF composition will adsorb at least a portion of the carbon dioxide in percentage amounts as detailed above. The MOF compositions or articles containing the MOF compositions can also be placed in various types of rigid containers. For example, extrudates or pills or spheres can be housed in a bed through which the air or other gas stream is flowed through. The bed can be placed in various types of housings such as filter canisters having an inlet and outlet. Fabrics (both woven and non-woven) can also be formed into filters such as but not limited to pleated filters which again can be housed in rigid containers such as cartridges through which the stream to be treated flows through. Pleated filters can also be supported in various shaped and sized frames and the gas stream flowed through it. The frames can be made of various types of materials such as but not limited to metal, wood and plastic. Fiber glass can be formed into glass wool and housed in rigid filter frames.

In a specific embodiment, the method is applied to a gas mixture containing in addition to carbon dioxide at least one gas selected from the group consisting of nitrogen, oxygen, methane, hydrogen, water vapor, carbon monoxide, hydrogen sulfide, sulfur dioxide, nitrogen dioxide, and any mixture of the foregoing. More specifically, the gas mixture contains at least two gases in addition to CO₂. In an embodiment, the gas mixture contains water vapor. In an embodiment, the gas mixture contains water vapor and nitrogen. In a specific embodiment, the gas mixture is selected from the group consisting of atmospheric gas, natural gas, air, shale gas, and flue gas. In a specific embodiment, the atmospheric gas, natural gas, air, shale gas, or flue gas contains water vapor.

In a specific embodiment, the contacting step is carried out at a temperature ranging from −20° C. to 200° C., or from 0° C. to 200° C. or from ambient temperature to 150° C. or from ambient temperature to 100° C. In more specific embodiments, the contacting step is carried out at a temperature ranging from −20° C. to 190° C., or from 0° C. to 180° C., or from 5° C. to 150° C., or from 25° C. to 125° C., or from 50° C. to 100° C. In specific embodiments, the contacting step is carried out at a temperature of about −20, about −10, about 0, about 10, about 20, about 30, about 40, about 50, about 60, about 70, about 80, about 90, about 100, about 110, about 120, about 130, about 140, about 150, about 160, about 170, about 180, about 190 or 200° C.

In a specific embodiment of the method, the partial pressure of CO₂ in the gas ranges from 0.001 atm to 200 atm. In more specific embodiments, the partial pressure of CO2 in the gas ranges from 0.01 to 200 atm, from 0.1 to 150 atm, from 0.1 to 100 atm, from 1 to 50 atm. In a more specific embodiment, the partial pressure of CO₂ in the gas ranges from 0.05 atm to 1 atm or 0.05 to 0.5 atm. In more specific embodiments, the partial pressure of CO₂ in the gas is about 0.001, about 0.01, about 0.1, about 1, about 10, about 20, about 30, about 40, about 50, about 60, about 70, about 80, about 90, about 100, about 110, about 120, about 130, about 140, about 150, about 160, about 170, about 180, about 190, about 200 atm, or an intermediate range between any of the foregoing.

Also provided herein is a method of absorbing carbon dioxide, storing the carbon dioxide, or absorbing and storing the carbon dioxide, the method comprising contacting a gas containing CO₂ with a MOF composition as disclosed herein under conditions suitable for absorption of the carbon dioxide. In a specific embodiment of this method, the partial pressure of CO₂ in the gas ranges from 0.001 atm to 200 atm. In more specific embodiments, the partial pressure of CO₂ in the gas ranges from 0.01 to 200 atm, from 0.1 to 150 atm, from 0.1 to 100 atm, from 1 to 50 atm. In a more specific embodiment, the partial pressure of CO₂ in the gas ranges from 0.05 atm to 1 atm or 0.05 to 0.5 atm. In more specific embodiments, the partial pressure of CO₂ in the gas is about 0.001, about 0.01, about 0.1, about 1, about 10, about 20, about 30, about 40, about 50, about 60, about 70, about 80, about 90, about 100, about 110, about 120, about 130, about 140, about 150, about 160, about 170, about 180, about 190, about 200 atm, or an intermediate range between any of the foregoing.

In some embodiments, carbon dioxide can be desorbed from the MOF compositions to regenerate the MOF composition so that it can be reused. In some embodiments the MOF composition that has adsorbed carbon dioxide can be regenerated by either heating, or evacuating, or heating and evacuating the metal organic framework composition that has adsorbed carbon dioxide to remove the adsorbed carbon dioxide from the MOF composition. Desorption can be carried out under reduced pressure, or by pressure swing techniques, or temperature swing techniques, or a combination thereof.

In an embodiment, an apparatus comprises an adsorbent composition comprising a metal-organic framework (MOF) composition wherein the MOF composition is the reaction product of a reaction comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted, and at least one cycloazocarbyl compound that is either unsubstituted or monosubstituted. The apparatus can be used to separate carbon dioxide from a gas mixture comprising carbon dioxide by allowing the gas mixture to come into contact with said adsorbent composition. In a further embodiment, the apparatus may contact the gas mixture with the adsorbent composition to separate carbon dioxide from the gas mixture.

The disclosure herein is further understood through the following examples, which are presented by way of illustration and not by way of limitation.

### Examples

Standard Protocol A: In individual 40 mL vials with a stir bar and pressure release caps, oxalic acid (0.6375 g, 1 Eq, 7.081 mmol) and triazole (3-methyl-1H-1,2,4-triazole (588.4 mg, 1 Eq, 7.081 mmol) and 3-amino-1,2,4-triazole (595.4 mg, 1 Eq, 7.081 mmol)) was mixed in Water (20.00 mL). The vials were placed into a preheated aluminum pie block at 70° C. and stirred at 800 rpm for 10 min. Zinc(II)Biscarbonate(hexahydroxide) (1.555 g, 2 Eq Zn₂⁺, 2.832 mmol) was added gradually to the solutions with gas evolution over ˜3 min. The mixture was stirred an additional 10 min at 70° C. The stir rate was decreased to 400 rpm, the temperature on the pie block was set to 90° C. and stirred for 15 hours.

Alternative Protocol B: In individual 40 mL vials with a stir bar and pressure release caps, oxalic acid (0.6375 g, 1 Eq, 7.081 mmol) and Zinc(II)Biscarbonate(hexahydroxide) (1.555 g, 2 Eq Zn₂⁺, 2.832 mmol) was added. Water (20.00 mL) was added to the solids with vigorous stirring. The vials were placed into a preheated aluminum pie block at 70° C. and stirred at 800 rpm for 30 min during which a white viscous slurry formed. 2.83 mL of a 5.0 M total triazole solution (2.5 M of 3-methyl-1,2,4-triazole (1 Eq, 7.081 mmol) and 2.5 M of 3-amino-1,2,4-triazole (1 Eq, 7.081 mmol)) was added to Zn₂(oxalate) slurry at 800 rpm with observable gas evolution. The stir rate was decreased to 400 rpm, the temperature on the pie block was set to 100° C. and stirred for 15 hours.

Alternative Protocol C: In individual 40 mL vials with a stir bar and pressure release caps, oxalic acid (0.6375 g, 1 Eq, 7.081 mmol) and Zinc(II)Oxide (1.152 g, 2 Eq Zn₂⁺, 14.16 mmol) was added. Water (20.00 mL) was added to the solids with vigorous stirring. The vials were placed into a preheated aluminum pie block at 70° C. and stirred at 800 rpm for 30 min. 2.83 mL of a 5.0 M total triazole solution (2.5 M of 3-methyl-1,2,4-triazole (1 Eq, 7.081 mmol) and 2.5 M of 3-amino-1,2,4-triazole (1 Eq, 7.081 mmol)) was added to Zn₂(oxalate) slurry at 800 rpm. The stir rate was decreased to 400 rpm, the temperature on the pie block was set to 100° C. and stirred for 15 hours.

Alternative Protocol D: In individual 40 mL vials with a stir bar and pressure release caps, oxalic acid (0.6375 g, 1 Eq, 7.081 mmol) and Zinc(II)X₂ (where X═Cl, NO₃, or OAc, 2 Eq Zn₂⁺, 14.16 mmol) was added. Water (20.00 mL) was added to the solids with vigorous stirring. The vials were placed into a preheated aluminum pie block at 70° C. and stirred at 800 rpm for 30 min. 2.83 mL of 10 N solution of sodium hydroxide (4 Eq, 28.32 mmol) was added to the solution and allowed to stir for an additional 10 min. 2.83 mL of a 5.0 M total triazole solution (2.5 M of 3-methyl-1,2,4-triazole (1 Eq, 7.081 mmol) and 2.5 M of 3-amino-1,2,4-triazole (1 Eq, 7.081 mmol)) was added to Zn₂(oxalate) slurry at 800 rpm. The stir rate was decreased to 400 rpm, the temperature on the pie block was set to 100° C. and stirred for 15 hours.

Work up: The mixtures were cooled to room temperature (˜25° C.). The solids were added to 50 mL centrifuge tubes and centrifuged. The supernatant was poured off and the solids were washed with water (2×), 1 ethanol/1 water (2×), and ethanol (2×) via centrifugation. The resulting solids were dried at room temperature and PXRDs were collected. This material was then dried at 100° C. under vacuum until a dynamic pressure (<0.1 Torr) was reached.

PXRD data was collected at ambient temperature on a Rigaku MiniFlex 600 at 40 kV, 15 mA for Cu (Kα (λ=1.5405 Å), with a Kβ filter. Typical measurements are performed with a 2θ range between 3 and 40, a step size of 0.03°, and a scan speed of 1° per minute. For all the samples, the experimental backgrounds were not corrected.

CO₂ and water sorption measurements were collected for surface area and pure gas uptake capacity. CO₂ isotherms were collected on a Microtrac Belsorp Max X instrument at 298K. Water isotherms were collected on Micromeritics 3Flex instrument at 298 K.

All N₂ gas adsorption and desorption measurements, unless stated otherwise, were performed on the Micromeritics Tristar II 3020 system (Micromeritics, Norcross, GA) at 77 K. Between 75-200 mg of samples were employed in each measurement. The specific surface areas for N2 were calculated using the Brunauer-Emmet Teller (BET) model in the range of 0.005<P/P0<0.05. The N₂ uptakes were measured at P/P0=0.9, where P/P0 is the measured pressure relative to atmospheric pressure.

The foregoing protocol was used to prepare Example 3 in Table 1 below. Using the standard protocol above but different molar ratios of various reactants, the following examples were prepared, where reactants are indicated by the following definitions and stated in molar equivalents:
TZ=1,2,4-triazole
ATZ=3-amino-1,2,4-triazole
MTZ=3-methyl-1,2,4-triazole
DATZ=3,5-diamino-1,2,4-triazole
DMTZ=3,5-dimethyl-1,2,4-triazole
Ox=oxalic acid
Zn=Zinc(II)Biscarbonate(hexahydroxide)

Examples A-I are Comparative Examples. Examples 1-11 are Working Examples of the disclosure. The Comparative Examples and Working Examples are set forth in Table 1, which lists the molar equivalents of each component of the MOF.

TABLE 1

| | Eq | Eq | Eq | Eq | Eq | Eq | Eq |
|---|---|---|---|---|---|---|---|
| Example | Zn | Ox | TZ | ATZ | MTZ | DATZ | DMTZ |
| Example A | 2 | 1 | 2 | — | — | — | — |
| Example B | 2 | 1 | — | 2 | — | — | — |
| Example C | 2 | 1 | — | — | 2 | — | — |
| Example D | 2 | 1 | .5 | — | 1.5 | — | — |
| Example E | 2 | 1 | 1 | — | 1 | — | — |
| Example F | 2 | 1 | 1.5 | — | .5 | — | — |
| Example G | 2 | 1 | 1.5 | .5 | — | — | — |
| Example H | 2 | 1 | 1 | 1 | — | — | — |
| Example I | 2 | 1 | .5 | 1.5 | — | — | — |
| Example 1 | 2 | 1 | — | .5 | 1.5 | — | — |
| Example 2 | 2 | 1 | — | 1.5 | .5 | — | — |
| Example 3 | 2 | 1 | — | 1 | 1 | — | — |
| Example 4 | 2 | 1 | 1.5 | — | — | — | .5 |
| Example 5 | 2 | 1 | 1 | — | — | — | 1 |
| Example 6 | 2 | 1 | — | 1.5 | — | — | .5 |
| Example 7 | 2 | 1 | — | 1.7 | — | — | .3 |
| Example 8 | 2 | 1 | — | 1.8 | — | — | .2 |
| Example 9 | 2 | 1 | 1.5 | — | — | .5 | — |
| Example 10 | 2 | 1 | 1 | — | — | 1 | — |
| Example 11 | 2 | 1 | — | — | 1.5 | .5 | — |
| Example 12 | 2 | 1 | — | — | 1 | 1 | — |

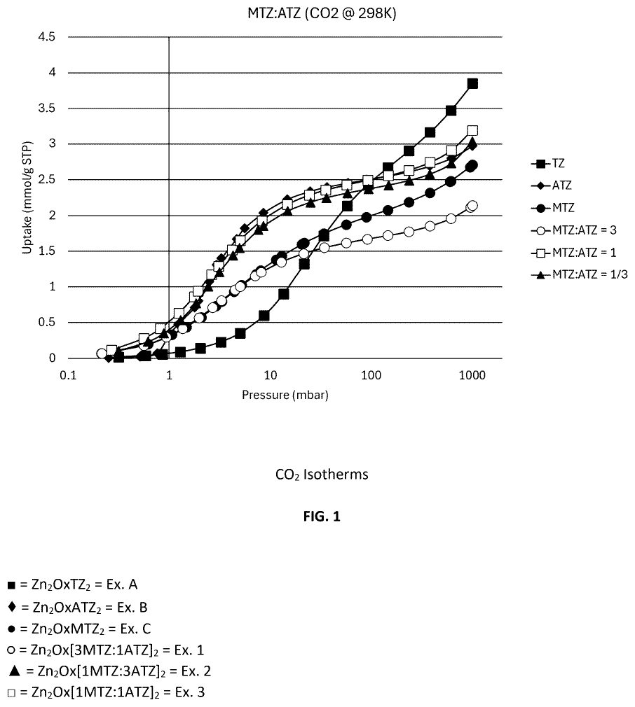

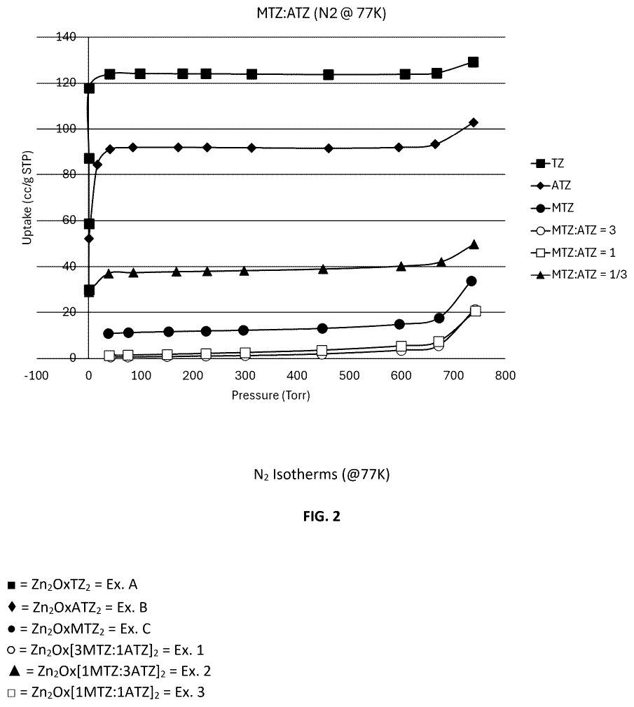

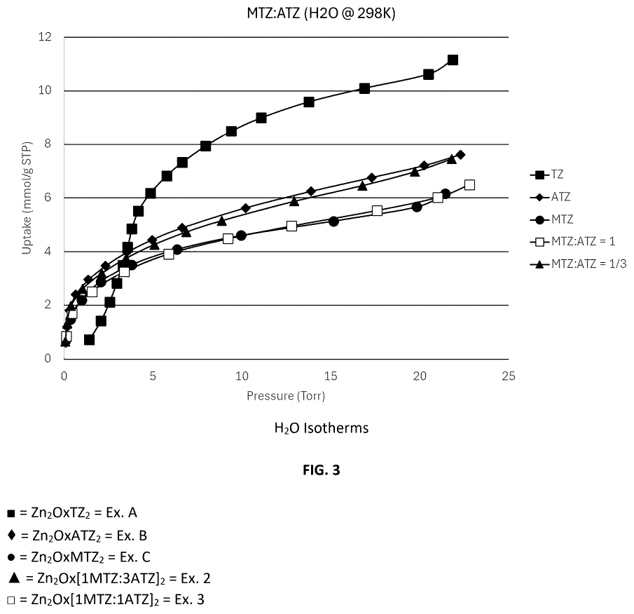

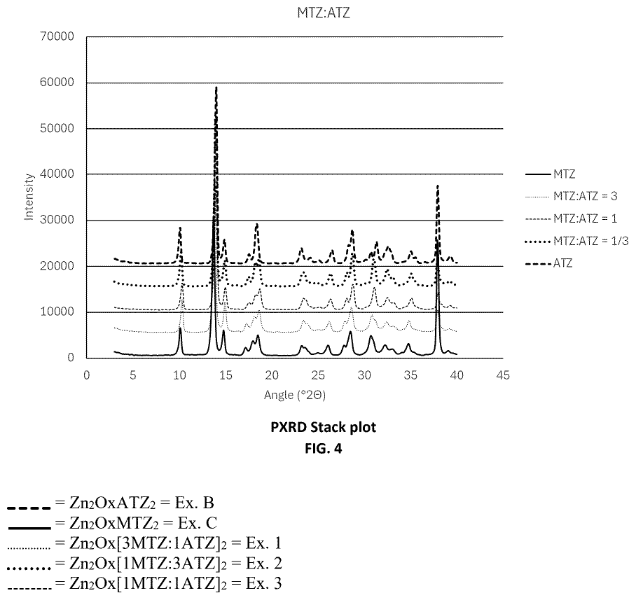

Referring to FIG. 1, CO₂ isotherms are presented of Comparative Examples A, B, and C and Working Examples 1, 2 and 3. It may be seen that each of the MOF compositions shows increased CO₂ adsorption at increased pressure. FIG. 2 presents N₂ isotherms for the same MOFs. It may be seen that the MOF compositions of Working Examples 1, 2 and 3 adsorb substantially less N₂ than the MOF compositions of Comparative Examples A and B. Referring to FIG. 3, it may be seen that Comparative Example A adsorbs substantially more water vapor than Working Examples 2 and 3. FIG. 4 contains PXRD spectra in a stack plot of Comparative Examples B, C, and 1-3.

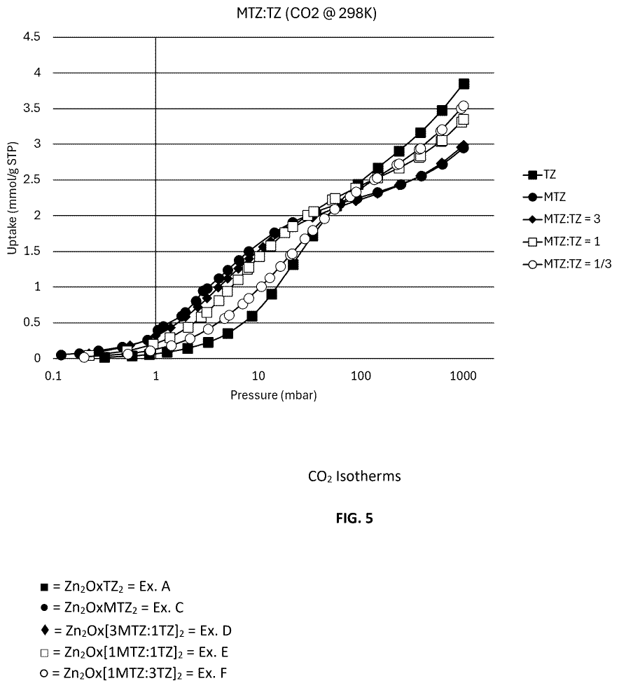

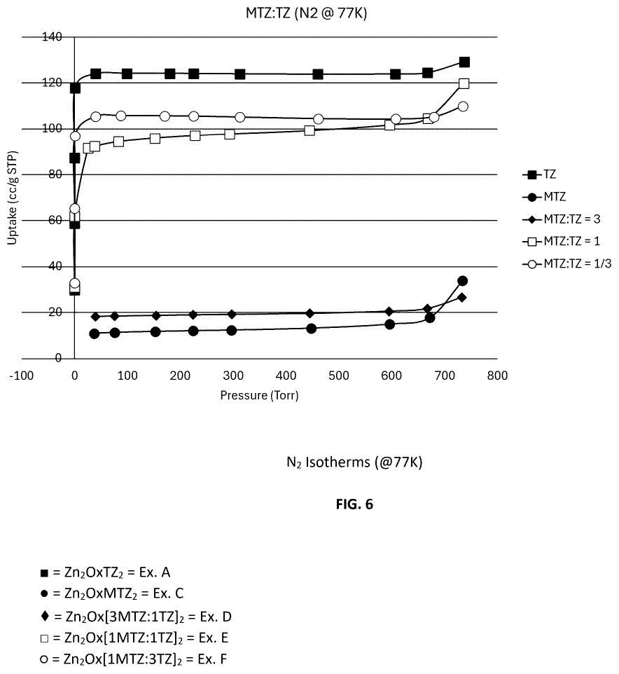

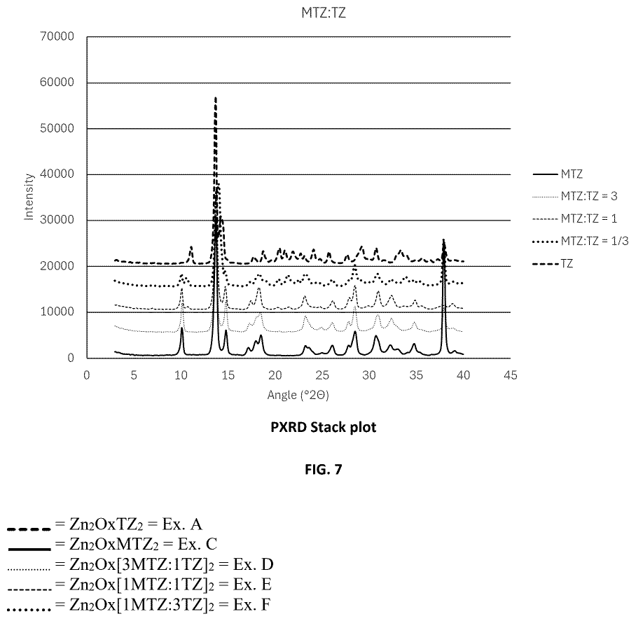

FIGS. 5 and 6 present CO₂ isotherms and N₂ isotherms, respectively, for Comparative Examples A, C, D, E, and F. FIG. 7 contains PXRD spectra in a stack plot of Comparative Examples A, C, D, E, and F.

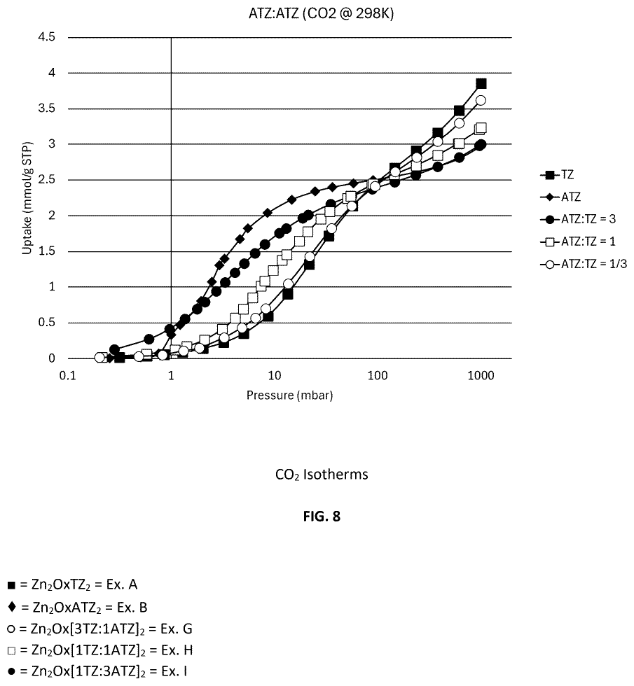

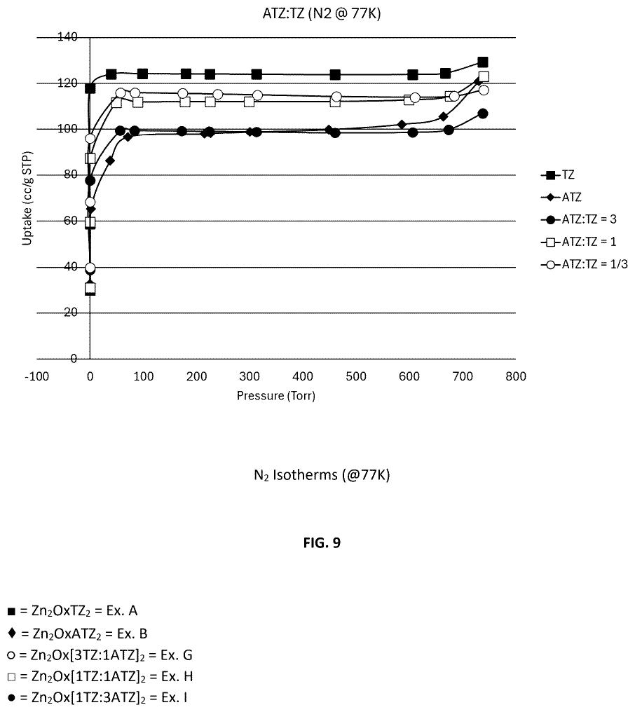

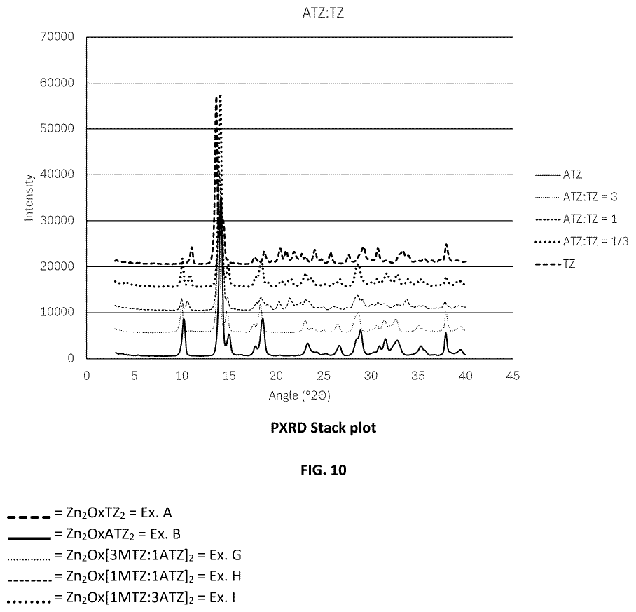

FIGS. 8 and 9 present CO₂ isotherms and N₂ isotherms, respectively, for Comparative Examples A, B, G, H and I. FIG. 10 contains PXRD spectra in a stack plot of Comparative Examples A, B, G, H and I.

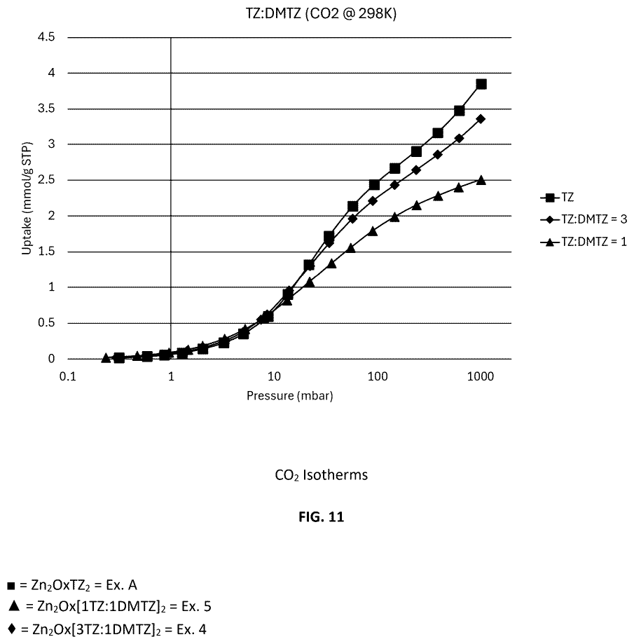

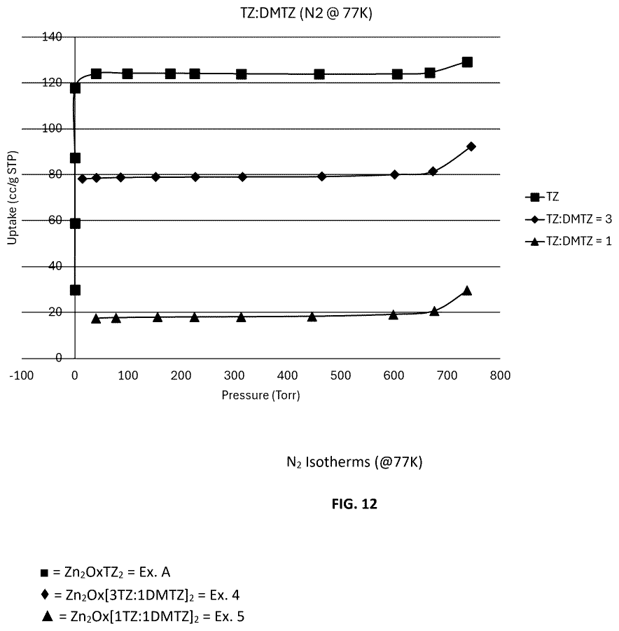

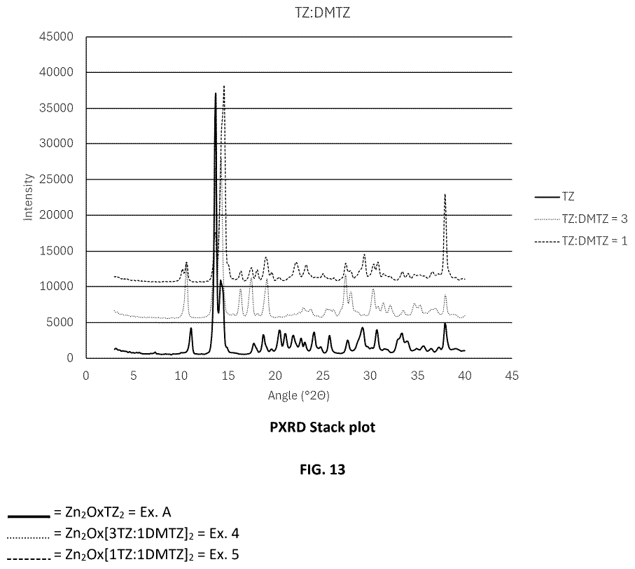

FIGS. 11 and 12 present CO₂ isotherms and N2 isotherms, respectively, for Comparative Example A and Working Examples 4 and 5. It may be seen that Working Example 4 has almost the same CO₂ adsorption as Comparative Example A, but substantially less N₂ adsorption. Additionally, it is possible that use of 3,5-dimethyl-1,2,4-triazole as in Examples 4 and 5 will continue to adsorb CO₂ at higher humidity levels. FIG. 13 contains PXRD spectra in a stack plot of Comparative Example A and Working Examples 4 and 5.

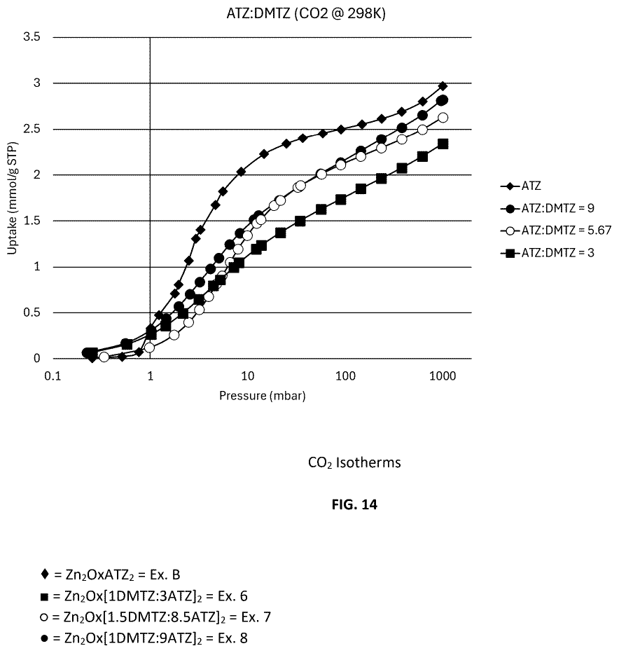

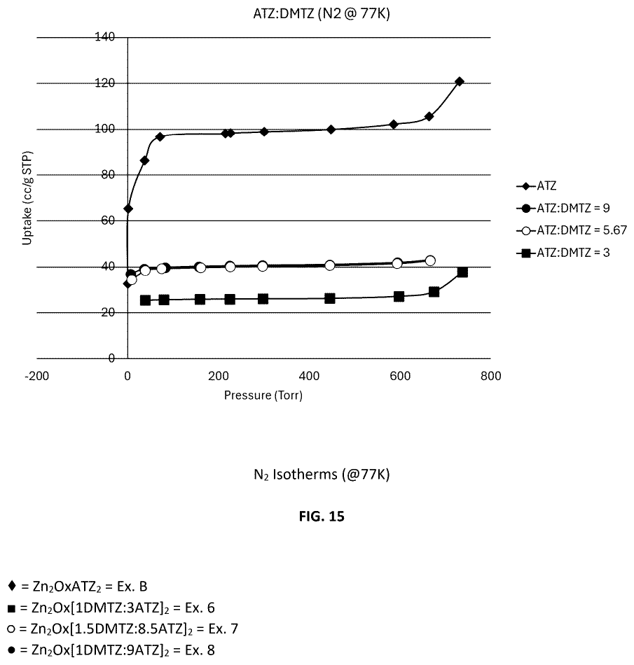

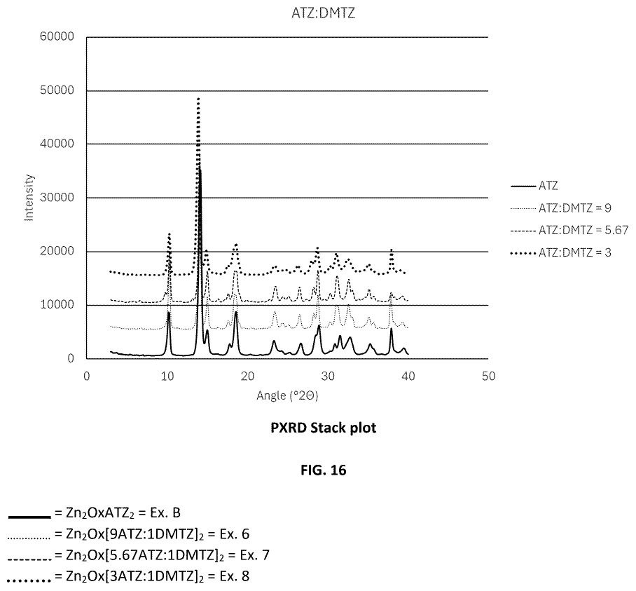

FIGS. 14 and 15 present CO₂ isotherms and N₂ isotherms, respectively, for Comparative Example B and Working Examples 6, 7 and 8. It may be seen that each of the Working Examples 6, 7 and 8 have CO₂ adsorption levels approaching that of Comparative Example B but have significantly lower N adsorption. Additionally, it is possible that use of 3,5-dimethyl-1,2,4-triazole as in Examples 6, 7 and 8 will continue to adsorb CO₂ at higher humidity levels. FIG. 16 contains PXRD spectra in a stack plot of Comparative Example B and working Examples 6, 7 and 8.

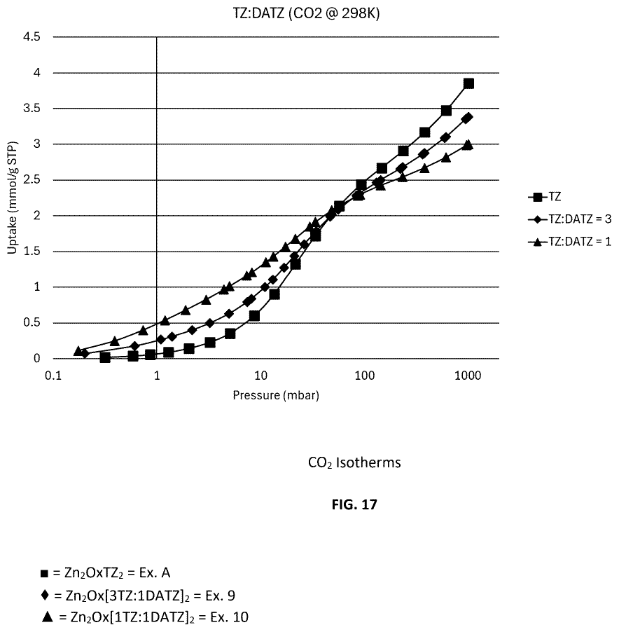

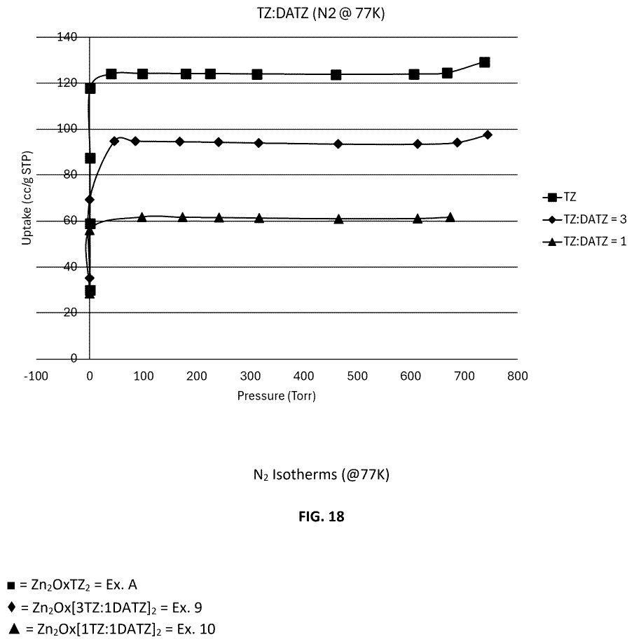

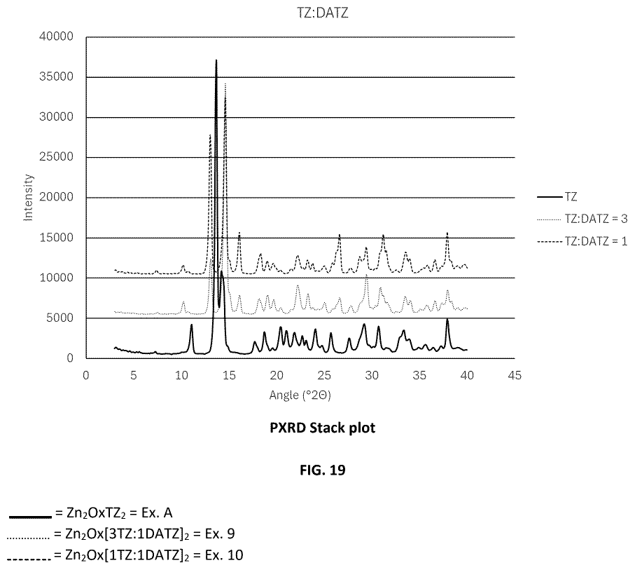

FIGS. 17 and 18 present CO₂ isotherms and N₂ isotherms, respectively, for Comparative Example A and Working Examples 9 and 10. It may be seen that Comparative Example A and Working Examples 9 and 10 have higher CO₂ adsorption at lower % CO₂, while Working Examples 9 and 10 have substantially lower N₂ adsorption than Comparative Example A. FIG. 19 contains PXRD spectra in a stack plot of Comparative Example A and Working Examples 9 and 10.

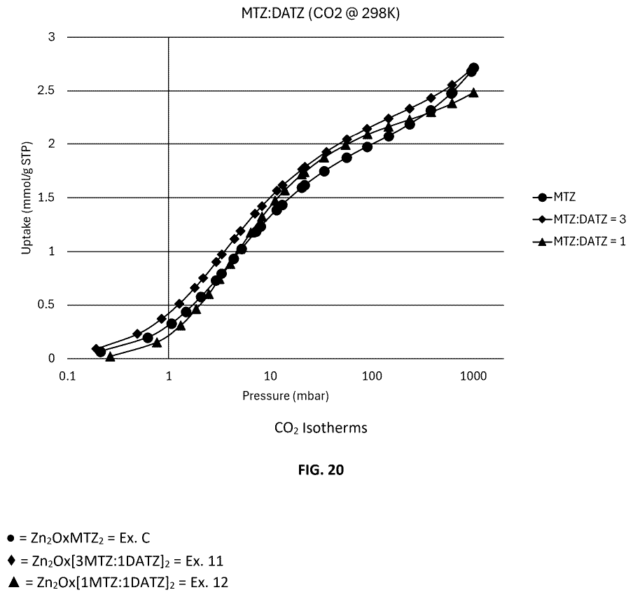

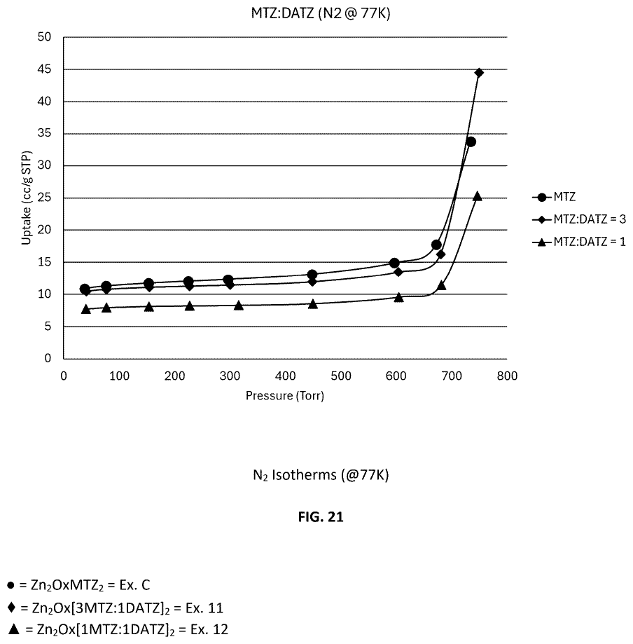

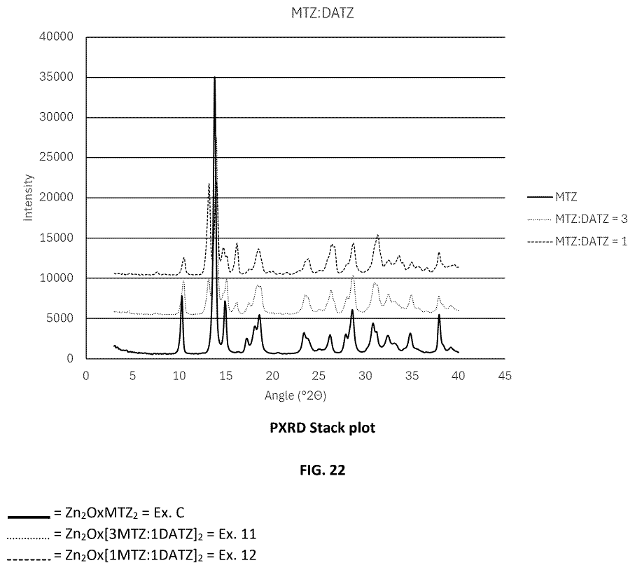

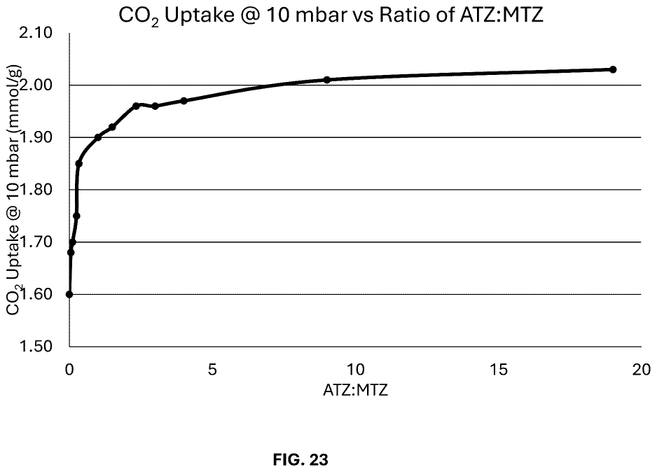

FIGS. 20 and 21 present CO₂ isotherms and N₂ isotherms, respectively, for Comparative Example C and Working Examples 11 and 12. It may be seen that Working Examples 11 and 12 each have CO₂ adsorption levels approaching that of Comparative Example C. This may show that substitution of the more expensive 3-methyl-1,2,4-triazole with the less expensive 3,5-diamine-1,2,4 triazole provides a MOF composition that substantially retains CO₂ adsorption capacity, while not increasing N₂ adsorption. FIG. 22 contains PXRD spectra in a stack plot of Comparative Example C and Working Examples 11 and 12. FIG. 23 is a graph showing carbon dioxide uptake versus the ratio of 3-amino-1,2,4-triazole (ATZ) and 3-methyl-1,2,4-triazole (MTZ).

Table 2 shows the results of CO2 uptake at 10 mbar (mm/g) at 25° C. and shows the ratio of ATZ:MTZ and MTZ:ATZ.

TABLE 2

| | Eq | Eq | Eq | Eq | | CO2 Uptake @ 10 mbar | |
|---|---|---|---|---|---|---|---|
| Entry | Zn | Ox | MTZ | ATZ | ATZ:MTZ | (mmol/g) @ 25° C. | MTZ:ATZ |
| 1 | 2 | 1 | 2 | 0 | 0 | 1.60 | 0 |
| 2 | 2 | 1 | 1.9 | 0.1 | 0.052632 | 1.68 | 0.052632 |
| 3 | 2 | 1 | 1.8 | 0.2 | 0.111111 | 1.70 | 0.111111 |
| 4 | 2 | 1 | 1.6 | 0.4 | 0.25 | 1.75 | 0.25 |
| 5 | 2 | 1 | 1.5 | 0.5 | 0.333333 | 1.85 | 0.333333 |
| 6 | 2 | 1 | 1 | 1 | 1 | 1.90 | 1 |
| 7 | 2 | 1 | 0.8 | 1.2 | 1.5 | 1.92 | 1.5 |
| 8 | 2 | 1 | 0.6 | 1.4 | 2.333333 | 1.96 | 2.333333 |
| 9 | 2 | 1 | 0.5 | 1.5 | 3 | 1.96 | 3 |
| 10 | 2 | 1 | 0.4 | 1.6 | 4 | 1.97 | 4 |
| 11 | 2 | 1 | 0.2 | 1.8 | 9 | 2.01 | 9 |
| 12 | 2 | 1 | 0.1 | 1.9 | 19 | 2.03 | 19 |
| 13 | 2 | 1 | 0 | 2 | | 2.03 | 100 |

Although the foregoing examples refer to particular embodiments, it will be understood that the scope of the claims is not so limited. It will be understood by those of ordinary skill in the art that various modifications may be made to the disclosed embodiments and that such modifications are intended to be within the scope of the claims.

What is claimed is:

1. An adsorbent composition comprising a metal-organic framework (MOF) composition wherein the MOF composition is the reaction product of a reaction mixture comprising zinc ions, oxalate, and one or more substituted cycloazocarbyl compounds selected from either (a) at least two different cycloazocarbyl compounds, each of which is at least mono-substituted, or (b) at least one cycloazocarbyl compound that is di-substituted and one cycloazocarbyl compound that is either unsubstituted or mono-substituted.

2. The composition of claim 1 wherein the substituents on the at least two different mono-substituted cycloazocarbyl compounds and the at least one disubstituted cycloazocarbyl compounds are independently selected from the group consisting of methyl, ethyl, propyl and NR′R″, where R′ and R″ are independently selected from H and C₁-C₃ alkyl.

3. The composition of claim 1 wherein the one or more substituted cycloazocarbyl compounds are substituted triazoles.

4. The composition of claim 1 wherein the at least two different mono-substituted cycloazocarbyl compounds are selected from the group consisting of 3-methyl-1,2,4-triazole (MTZ) and 3-amino-1,2,4-triazole (ATZ).

5. The composition of claim 1 wherein the MOF comprises at least one di-substituted cycloazocarbyl compound selected from the group consisting of 3,5-diamino-1,2,4-triazole and 3,5-dimethyl-1,2,4-triazole.

6. The composition of claim 1 wherein the MOF comprises 3-amino-1,2,4-triazole and 3,5-diamino-1,2,4-triazole.

7. The composition of claim 1 wherein the MOF comprises 1,2,4-triazole and 3,5-dimethyl-1,2,4-triazole.

8. The composition of claim 1 wherein the MOF comprises 3-amino-1,2,4-triazole and 3,5-dimethyl-1,2,4-triazole.

9. The composition of claim 1 wherein the MOF comprises 1,2,4-triazole and 3,5-diamino-1,2,4-triazole.

10. The composition of claim 1 wherein the MOF comprises 3-methyl-1,2,4-triazole and 3,5-diamino-1,2,4-triazole.

11. The composition of claim 1 wherein the molar ratio in the reaction mixture of the at least two different cycloazocarbyl compounds each of which is at least mono-substituted is in the range of 20:1 to 1:20, or 15:1 to 1:15, or 10:1 to 1:10, or 5:1 to 1:5, or 3:1 to 1:3.

12. An apparatus comprising the composition of claim 1, wherein said apparatus can be used to separate carbon dioxide from a gas mixture comprising carbon dioxide by allowing the gas mixture to come into contact with said composition.

13. A method of making an adsorbent composition comprising at least one metal-organic framework (MOF) composition comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted, the method comprising
i. providing an aqueous mixture comprising oxalic acid and either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted,
ii. adding a zinc precursor to the mixture to form a reaction mixture, and
iii. reacting the reaction mixture to form a MOF composition comprising zinc, oxalate, and either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted.

14. The method of claim 13 further comprising the step of separating the MOF composition from the reaction mixture.

15. A process for removing carbon dioxide from a gas mixture, the process comprising:
i. providing a contactor comprising an adsorbent composition comprising at least one metal-organic framework (MOF) composition comprising zinc ions, oxalate and one or more substituted cycloazocarbyl compounds selected from either (a) at least two different cycloazocarbyl compounds, each of which is at least mono-substituted, or (b) at least one cycloazocarbyl compound that is di-substituted and at least one cycloazocarbyl compound that is either unsubstituted or monosubstituted;
ii. admitting the gas mixture as a feed stream into the contactor, adsorbing at least a portion of the carbon dioxide on and/or in the sorbent;
iii. producing a first product stream depleted in the carbon dioxide relative to the gas mixture.

16. The process of claim 15, wherein a concentration of the carbon dioxide in the feed stream is approximately in the range of 0.5-20% concentration.

17. The process of claim 15 wherein the gas mixture further comprises at least one gas selected from nitrogen, oxygen, methane, hydrogen, water vapor, carbon monoxide, hydrogen sulfide, sulfur dioxide, nitrogen dioxide, and mixtures of any of the foregoing.

18. The process of claim 15 wherein substituents on the at least two different mono-substituted cycloazocarbyl compounds and the at least one disubstituted cycloazocarbyl compounds are independently selected from the group consisting of methyl, ethyl, propyl and NR′R″, where R′ and R″ are independently selected from H and C₁-C₃ alkyl.

19. The process of claim 15 wherein the at least two different mono-substituted cycloazocarbyl compounds are selected from the group consisting of 3-methyl-1,2,4-triazole (MTZ) and 3-amino-1,2,4-triazole (ATZ).

20. The process of claim 15 wherein the adsorbent composition comprises at least one di-substituted cycloazocarbyl compound selected from the group consisting of 3,5-diamino-1,2,4-triazole and 3,5-dimethyl-1,2,4-triazole.
